(19) United States
(12) Patent Application Publication
(10) Pub. No.: US 2026/0312622 A1
(43) Pub. Date: Oct. 8, 2026

(54) A SYSTEM FOR ENHANCING NFC COMMUNICATION WITH A PROGRAMMABLE DRIVER INSIDE A METAL HOUSING

(71) Applicant: SIGNIFY HOLDING B.V., EINDHOVEN (NL)

(72) Inventors: EDDY BOS, EERSEL (NL); HEMANTH MURALA, EINDHOVEN (NL)

(21) Appl. No.: 18/998,612

(22) PCT Filed: Jul. 17, 2023
(86) PCT No.: PCT/EP2023/069753

§ 371 Date: Jan. 27, 2025

(30) Foreign Application Priority Data
Jul. 26, 2022 (EP) 22186841.7

(51) Int. Cl. H04B 5/77; H04B 5/26

(52) U.S. Cl. CPC H04B 5/77; H04B 5/26

(57) ABSTRACT

A system (100) comprising an electronic device (200) comprising: an electronic component (210); a programmable driver (220) configured to regulate a voltage or current supply of the electronic component (210); wherein the programmable driver (220) comprises an integrated Near-Field Communication, NFC, tag (225) with an antenna (226), and the NFC tag (225) is configured to assist an external NFC reader (400) to access the programmable driver (220) for configuring the electronic component (210); a metal housing (230) comprising an opening (231) for inserting a plug; wherein the programmable driver (220) is placed inside the metal housing (230) with the antenna (226) of the NFC tag (225) towards the opening (231); and a passive NFC repeater (300) configured to connect to the NFC tag (225) through the opening (231) to extend a communication range of the NFC tag (225) to establish an NFC communication link with the external NFC reader (400).

### FIELD OF THE INVENTION

The invention relates to the field of establishing a communication link with a programmable driver, such as via Near-Field Communication (NFC) communication. More particularly, various apparatus, systems, and methods are disclosed herein related to the enhancement of NFC communication for a programmable driver inside a metal housing.

### BACKGROUND OF THE INVENTION

Programmable drivers are more and more adopted for reconfiguring electronic components. The control signals may be provided to a programmable driver either via a wire/cable or via a wireless link. A wirelessly programmable driver brings great convenience and flexibility to a system, which is more attractive from application point of view.

Currently, most of the wirelessly programmable drivers that are commercially available are built on top of NFC technology. For example, the control signals of a programmable driver are provided from an external NFC reader to an NFC tag integrated in the programmable driver. Since a typical communication distance of an NFC link is only a few cm, it may be a problem when a programmable driver has to be assembled in a housing that comprises many other electronic components. When the housing is a metal housing, the NFC link may be even shielded completely, and the programmable driver is no longer reachable from outside. Thus, a solution is needed to solve such problems.

US2019147202A1 relates to systems and methods for programming a network transceiver via RFID communication.

### SUMMARY OF THE INVENTION

In view of the above, the present disclosure is directed to apparatus and systems for extending an NFC link for a programmable driver placed inside a metal housing. More particularly, the goal of this invention is achieved by a system as claimed in claim 1, and by a kit for use as claimed in claim 8.

In accordance with a first aspect of the invention a system is provided. A system comprises an electronic device comprising an electronic component; a programmable driver configured to regulate a voltage or current supply of the electronic component; wherein the programmable driver comprises an integrated Near-Field Communication, NFC, tag with an antenna, and the NFC tag is configured to assist an external NFC reader to access the programmable driver for configuring the electronic component; a metal housing comprising an opening for inserting a plug; wherein the programmable driver is placed inside the housing with the antenna of the NFC tag towards the opening. The system further comprises a passive NFC repeater configured to connect to the NFC tag through the opening to extend a communication range of the NFC tag to establish an NFC communication link with the external NFC reader; wherein the passive NFC repeater is integrated in an add-on for removable insertion in the opening, and the add-on is a tool used for configuring the electronic component with the passive NFC repeater placed at an end of the tool fitting to the opening.

A programmable driver provides more flexibility for configuring electronic components. One or more settings of the electronic component can be reconfigured during installation or during usage. For example, the one or more settings may be adapted to a deployment scene, or a user preference.

A configuration of the programmable driver is set via the NFC communication link. Near-Field Communication (NFC) is a set of communication protocols that enables communication between two electronics devices over typically 4 cm or less. NFC is based on inductive coupling between two antennas on NFC enabled devices communicating in one or both directions. The communication is typically carried out in the carrier frequency band of 13.56 MHz, which is a globally available unlicensed radio frequency ISM band.

Reconfiguring the electronic component via such a wireless link further improves the flexibility of the system. However, due to the limited communication distance of NFC and the shielding effect on electromagnetic wave by the metal housing, the NFC link may be impaired or even blocked completely in such a system.

An NFC repeater or NFC extender is configured to extend the communication range of the NFC tag, which may be implemented as a passive component to relay an NFC signal. The NFC repeater is deployed to relay the signals through the hole on the metal housing of the electronic device, assisting the establishment of a communication link between the built-in NFC tag and the external NFC reader.

Advantageously, the electronic component is a light source.

The light source or light emitter may be one of a light-emitting diode (LED), a laser diode, a vertical-cavity surface-emitting laser (VCSEL), or an Edge Emitting Laser Diode (EELD).

In one example, the electronic device is a luminaire, and the light source is used for illumination.

NFC has been used in the lighting industry, e.g., for identification, control, or configuration of components such as drivers. NFC programming of luminaire drivers is rapidly gaining popularity as a flexible and simple method to set the operating characteristics of drivers inside luminaires.

The programmable driver may be a driver of the light source, such as a LED driver. NFC allows the manufacturer to wirelessly set the LED driver operating parameters, such as operating current, constant lumen output and dimming levels. This can be done on a manufacturing line without the need to apply mains voltage to the driver, reducing effort in the production line to protect the workers from mains voltage. This also allows a user to wirelessly adjust the settings according to a user preference.

The NFC reader is a hardware device for exchanging data with an NFC tag. The NFC reader can both read from and write to an NFC Tag. The NFC tag is a chip that can be used as a data storage that can be read from, and under some circumstances written to, by an NFC Reader. The tag is a passive device and activated by the energy contained within the signal emitted by the NFC reader. In an NFC programming system, the NFC reader may be connected to a host device and receive its instructions from this host device. The NFC reader wirelessly transfers the programming data to an NFC tag inside the LED driver. The parameters are programmed using an NFC reader in combination with software that is specific to the LED driver vendor. This software typically runs on a standard host device, such as a controller, a laptop, a smartphone, a tablet, or a commissioning device. After such a programming phase, the LED driver operating parameters are at the desired settings.

Preferably, the passive NFC repeater comprises two coils electrically connected to each other.

The two coils may be connected by a metal wire. One coil picks up an electromagnetic wave and converts it into an electric current, while the other coil generates an electromagnetic wave again. One coil may be positioned at a sending antenna, such as an antenna of the NFC reader, and the other coil may be positioned close to a receiving antenna, such as an antenna of the NFC tag.

Beneficially, the passive NFC repeater is configured to passively relay an electrical signal between the two coils.

As one option, the passive NFC repeater is implemented as a magnetic induction repeater with two coils electrically connected to each other and configured to have the same resonance frequency.

In a preferred setup, the passive NFC repeater is integrated in an add-on for removable insertion in the opening.

The passive NFC repeater may be built in an add-on, which is standalone from the electronic device and can be inserted into the opening removably. Thus, the add-on may be inserted into the opening only during a commissioning procedure and can be removed from the opening immediately after the commissioning procedure has completed.

Beneficially, the passive NFC repeater is built in a housing with an elongated shape for inserting into the opening.

Preferably, the NFC repeater shall be placed 1 cm or more away from the metal housing of the electronic device. The housing is made of non-metal material, which also creates some space between the NFC repeater and the metal housing of the electronic device.

In one example, the housing is in a pen shape.

In one example, the passive NFC repeater is integrated in a tool used for configuring the electronic component with the passive NFC repeater placed at an end of the tool fitting to the opening.

The tool may be a commissioning tool used to configure the electronic component.

In one option, the external NFC reader is comprised in a host device, such as a laptop, a tablet, a smartphone, a controller, or another commissioning device.

In another option, the external NFC reader is integrated with the passive NFC repeater in the tool.

In a preferred setup, the electronic device further comprises a plastic plug fixed to the opening with a cavity towards the interior of the electronic device, and the passive NFC repeater is configured for removable insertion into the cavity.

In one example, the passive NFC repeater is built in a plastic plug that fits to the opening of the metal housing of the electronic device. The plastic plug with integrated passive NFC repeater may be either detachably attached to the opening or fixedly attached to the opening.

In another setup, the passive NFC repeater is built in a plastic plug fixed to the opening.

Instead of having the NFC repeater built in an add-on standalone to the electronic device, it is also possible to have the NFC repeater integrated in a plastic plug fixed to the opening. In this option, the plastic plug is also part of the electronic device. Thus, the external NFC reader needs to be placed close to the plastic plug from outside for establishing an NFC link to program the electronic component.

Since the NFC repeater shall be preferably placed 1 cm or more away from the metal housing of the electronic device, it is beneficial that the housing of the add-on is of non-metal material and has certain thickness, and then when the add-on is inserted such a requirement can be satisfied.

In accordance with a second aspect of the invention an electronic device is provided. An electronic device comprises an electronic component; a programmable driver configured to regulate a voltage or current supply of the electronic component; wherein the programmable driver comprises an integrated Near-Field Communication, NFC, tag with an antenna, and the NFC tag is configured to assist an external NFC reader to access the programmable driver for configuring the electronic component; a metal housing comprising an opening for inserting a plug; wherein the programmable driver is placed inside the housing with the antenna of the NFC tag towards the opening; and a plastic plug fixed to the opening; wherein the plastic plug comprising a passive NFC repeater configured to connect to the NFC tag through the opening to extend a communication range of the NFC tag to establish an NFC communication link with the external NFC reader.

Beneficially, the electronic component is a light source.

The light source or light emitter may be one of a light-emitting diode (LED), a laser diode, a vertical-cavity surface-emitting laser (VCSEL), or an Edge Emitting Laser Diode (EELD).

In one example, the electronic device is a luminaire, and the light source is used for illumination.

In accordance with a third aspect of the invention a kit is provided. A kit for use comprises an electronic device comprising an electronic component; a programmable driver configured to regulate a voltage or current supply of the electronic component; wherein the programmable driver comprises an integrated Near-Field Communication, NFC, tag with an antenna, and the NFC tag is configured to assist an external NFC reader to access the programmable driver for configuring the electronic component; a metal housing comprising an opening for inserting a plug; wherein the programmable driver is placed inside the housing with the antenna of the NFC tag towards the opening; and a passive NFC repeater integrated in an add-on for removable insertion in the opening; wherein the passive NFC repeater is configured to connect to the NFC tag via the opening to extend a communication range of the NFC tag for assisting the NFC tag to establish an NFC communication link with an external NFC reader; wherein the add-on is a tool used for configuring the electronic component with the passive NFC repeater placed at an end of the tool fitting to the opening.

In this option, the passive NFC repeater built in a removable add-on to the electronic device may be comprised in a kit for sale and for use together with the electronic device.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 demonstrates a basic setup employing NFC programming of drivers;

FIG. 2 shows a block diagram of a system;

FIG. 3 demonstrates an implementation of a passive NFC repeater;

FIG. 4 shows an example of one implementation of the system;

FIG. 5 shows a further example of one implementation of the system;

FIG. 6 shows a block diagram of an electronic device; and

FIG. 7 shows a block diagram of a kit for use.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

Programmable drivers provide more flexibility for configuring electronic devices or components. One or more settings of an electronic component can be reconfigured during installation or during usage. For example, the one or more settings may be adapted to a deployment scene, or a user preference. In a commercially available product, one or more settings of a programmable driver is typically set via an NFC communication link. Near-Field Communication (NFC) is a set of communication protocols that enables communication between two electronics devices over typically 4 cm or less.

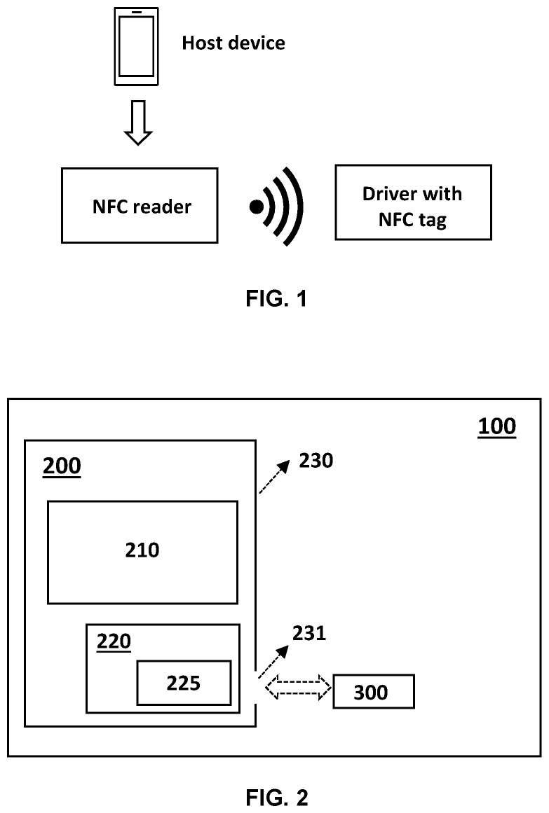

FIG. 1 demonstrates a basic setup employing NFC programming of drivers. The driver comprises an integrated NFC tag. An NFC reader (or sometimes called: interface) is connected to a computer. The reader communicates with an NFC tag in the driver. The range of communication with NFC is limited to a few cm.

As shown in FIG. 1, a host device, such as a laptop, a tablet, a smartphone, or a controller, may comprise software that sends instructions, control commands, or programming data to an NFC reader. The NFC reader may be integrated in the host device or communicatively coupled to the host device. The NFC reader wirelessly transfers, via an NFC link, the instruction, control command, or programming data to the NFC tag inside the programmable driver.

Reconfiguring the electronic component via such a wireless link further improves the flexibility of the system. However, the programmable driver may be assembled in an electronic device with a metal housing. Due to the limited communication distance of NFC and the shielding effect on electromagnetic wave by the metal housing, the NFC link may be impaired or even blocked completely in such a scenario. For example, when the driver is built in a metal luminaire, communication may be significantly impaired or even not possible due to the shielding of the metal for electromagnetic waves.

FIG. 2 shows a block diagram of a system 100 according to the present invention. As a basic setup, the system 100 comprises at least an electronic device 200 and a passive NFC repeater 300. The electronic device 200 further comprises an electronic component 210, a programmable driver 220, and a metal housing 230. The programmable driver 220 is configured to regulate a voltage or current supply of the electronic component 210. The programmable driver 220 comprises an integrated NFC tag 225 with an antenna 226, and the NFC tag 225 is used to assist an external NFC reader 400 to access the programmable driver 220 for configuring the electronic component 210. The metal housing 230 comprises an opening 231 for inserting a plug. The programmable driver 220 is placed inside the metal housing 230 with the antenna 226 of the NFC tag 225 towards the opening 231.

The passive NFC repeater 300 is configured to connect to the NFC tag 225 through the opening 231 to extend a communication range of the NFC tag 225 to establish an NFC communication link with the external NFC reader 400. The passive NFC repeater 300 is deployed to relay NFC signals through the hole 231 on the metal housing 230 of the electronic device 200, assisting the establishment of a communication link between the built-in NFC tag 225 and the external NFC reader 400.

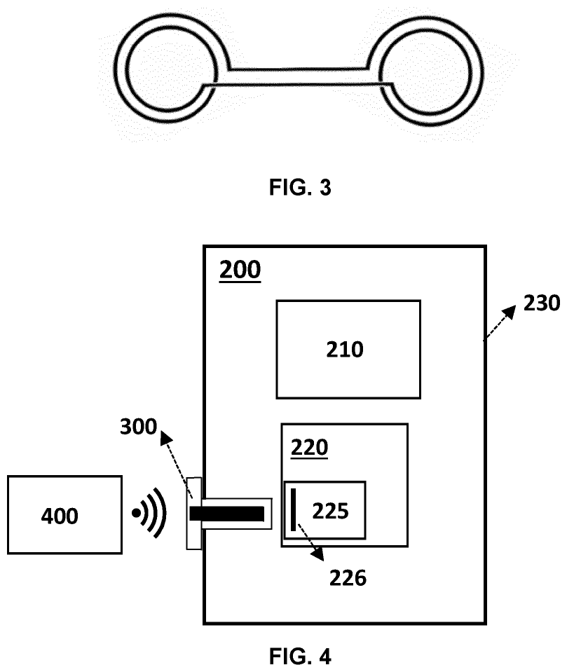

FIG. 3 demonstrates an implementation of a passive NFC repeater 300. The passive repeater 300 may be made of 2 coils, connected with a wire. One coil picks up the electromagnetic wave, converts it into an electric current, while the other coil creates an electromagnetic wave again. One coil operates as a “sending” antenna positioned next to the NFC reader, while the other coil may be placed close to the NFC antenna embedded in the driver.

In one example, the passive NFC repeater 300 is built in a plastic plug that fits to the opening 231 of the metal housing 230 of the electronic device 200. The plastic plug with integrated passive NFC repeater may be either detachably attached to the opening 231 or fixedly attached to the opening 231.

FIG. 4 shows an example of one implementation of the system 100. In this example, the passive repeater 300 is built in a plug fixed to the opening 231 of the metal housing 230 of the electronic device 200, such that the plug is a part of the electronic device 200. As one example, the electronic device 200 is a luminaire, and the electronic component 210 is a light source, such as a LED. The programmable driver 220 inside the luminaire 200 is directed with the antenna 226 of the NFC tag 225 to one coil of the passive repeater 300. And the external NFC reader 400 may establish an NFC communication link with the embedded NFC tag via the relay of the passive repeater 300.

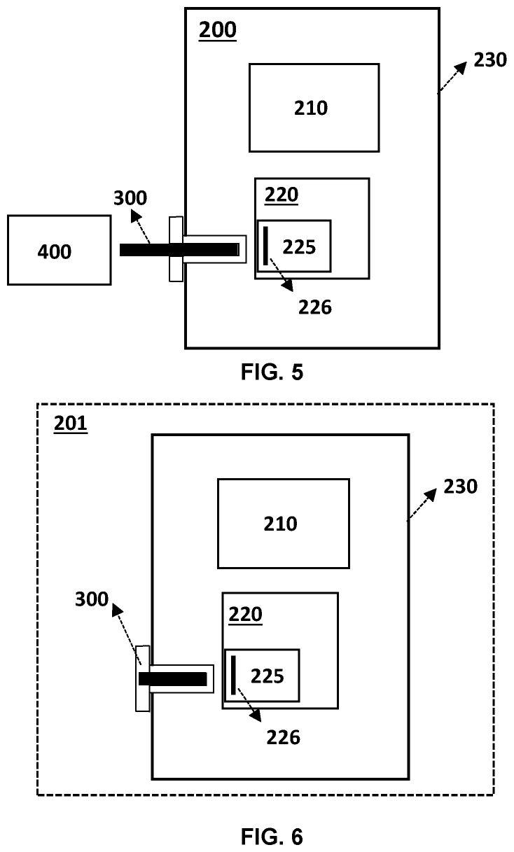

FIG. 5 shows a further example of one implementation of the system 100. This passive repeater 300 may be built in an add-on, which fits in an insert assembled in an electronic device 200 for removable insertion in the opening 231. The add-on is standalone from the electronic device 200 and may be inserted into the opening only during a commissioning procedure and can be removed from the opening immediately after the commissioning procedure has completed.

The add-on may be used as a tool for the configuration of the electronic component 210. The add-on or the tool may have a housing with an elongated shape suitable for removable insertion in the opening 231.

As one example, the passive repeater 300 may be built in a pen as a tool for configuration. For a luminaire 200 with a metal housing 230, NFC communication from the outside to access a programmable driver 220 inside the luminaire 200 is not possible, due to the metal repelling the electromagnetic flux lines. The pen with the passive repeater will bring the flux lines inside the luminaire 200 via the opening 231, when there is sufficient space, such as 1 cm or more, between the passive repeater and the metal housing of the electronic device or another metal component inside the electronic device.

FIG. 6 shows a block diagram of an electronic device 201. The electronic device 201 comprises an electronic component 210, a programmable driver 220, a metal housing 230 comprising an opening 231, and a plastic plug fixed to the opening 231. The programmable driver 220 is configured to regulate a voltage or current supply of the electronic component 210. The programmable driver 220 comprises an integrated Near-Field Communication, NFC, tag 225 with an antenna 226, and the NFC tag 225 is configured to assist an external NFC reader 400 to access the programmable driver 220 for configuring the electronic component 210. The metal housing 230 comprises an opening 231 for inserting a plug. The programmable driver 220 is placed inside the metal housing 230 with the antenna 226 of the NFC tag 225 towards the opening 231. The plastic plug is fixed to the opening 231. The plastic plug comprises a passive NFC repeater 300 configured to connect to the NFC tag 225 through the opening 231 to extend a communication range of the NFC tag 225 to establish an NFC communication link with the external NFC reader 400.

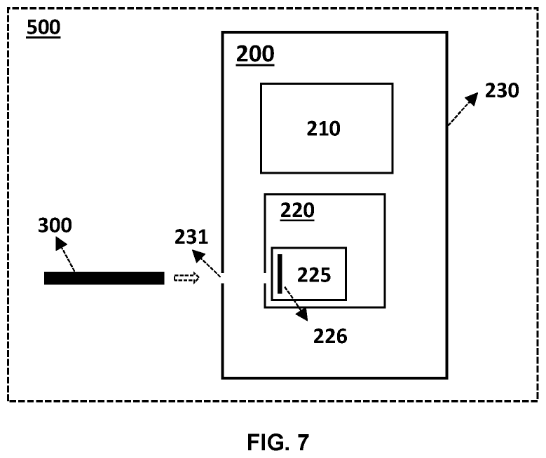

FIG. 7 shows a block diagram of a kit 500 for use. The kit 500 comprises an electronic device 200 and a passive NFC repeater 300 integrated in an add-on to the electronic device 200. The electronic device 200 comprises an electronic component 210, a programmable driver 220, and a metal housing 230. The programmable driver 220 is configured to regulate a voltage or current supply of the electronic component 210; wherein the programmable driver 220 comprises an integrated Near-Field Communication, NFC, tag 225 with an antenna 226, and the NFC tag 225 is configured to assist an external NFC reader 400 to access the programmable driver 220 for configuring the electronic component 210. The metal housing 230 comprising an opening 231 for inserting a plug. The programmable driver 220 is placed inside the housing with the antenna 226 of the NFC tag 225 towards the opening 231. The passive NFC repeater 300 is integrated in an add-on for removable insertion in the opening 231, and the passive NFC repeater 300 is configured to connect to the NFC tag 225 via the opening 231 to extend a communication range of the NFC tag 225 for assisting the NFC tag 225 to establish an NFC communication link with an external NFC reader 400.

As an example, the two coils of the passive NFC repeater 300 are electrically connected to each other. These coils are built in an add-on, such as a pen. The programmable driver 220 inside the luminaire 200 is directed with the antenna 226 of the NFC tag 225 to one coil. The antenna of an NFC reader 400 can be directed on the outside of the luminaire 200 towards the second coil of the passive repeater pen 300. The pen 300 can be shifted in the insert when the operator needs to program the driver. The pen will be removed once the programming is completed.

1. A system comprising:
an electronic device comprising:
an electronic component;
a programmable driver configured to regulate a voltage or current supply of the electronic component; wherein the programmable driver comprises an integrated Near-Field Communication, NFC, tag with an antenna, and the NFC tag is configured to assist an external NFC reader to access the programmable driver for configuring the electronic component; and
a metal housing comprising an opening for inserting a plug; wherein the programmable driver is placed inside the metal housing with the antenna of the NFC tag towards the opening;
the system further comprising:
a passive NFC repeater configured to connect to the NFC tag through the opening to extend a communication range of the NFC tag to establish an NFC communication link with the external NFC reader; wherein the passive NFC repeater is integrated in an add-on for removable insertion in the opening;
wherein the add-on is a tool used for configuring the electronic component with the passive NFC repeater placed at an end of the tool fitting to the opening.

2. The system of claim 1, wherein the electronic component is a light source.

3. The system of claim 1, wherein the passive NFC repeater comprises two coils electrically connected to each other.

4. The system of claim 3, wherein the passive NFC repeater is configured to passively relay an electrical signal between the two coils.

5. The system of claim 1, wherein the passive NFC repeater is built in a housing with an elongated shape for inserting into the opening.

6. The system of claim 1, wherein the external NFC reader is integrated with the passive NFC repeater in the tool.

7. The system of claim 1, wherein the electronic device further comprises a plastic plug fixed to the opening with a cavity towards the interior of the electronic device, and the passive NFC repeater is configured for removable insertion into the cavity.

8. (canceled)
